(19) United States
(12) Patent Application Publication
(10) Pub. No.: US 2008/0061050 A1
(43) Pub. Date: Mar. 13, 2008

(54) TUNGSTEN-COPPER WELDING TIP

(76) Inventor: Steve Walters, Bradenton, FL (US)

Correspondence Address: BROUSE MCDOWELL LPA, 388 SOUTH MAIN STREET, SUITE 500, AKRON, OH, 44311, US

(21) Appl. No.: 11/470,882

(22) Filed: Sep. 7, 2006

(51) Int. Cl. B23K 9/28

(52) U.S. Cl. 219/137.61

(57) ABSTRACT

An arc-welding contact tip to be provided to a welding torch for establishing an electric connection with a consumable electrode fed to a welding zone through the contact tip during welding operations is disclosed. The contact tip includes a housing to be secured to the welding torch and defining an elongated interior passage through which the consumable electrode is to be fed to the welding zone while the welding operations are being performed. At least a portion of a peripheral surface defining the interior passage is provided with an electrically conductive metal alloy comprising copper and tungsten. Further, the metal alloy includes about 50% by weight to about 90% by weight tungsten.

### BACKGROUND OF THE INVENTION

1. Field of the Invention

The present invention is directed generally to a welding tip, and more specifically, to a welding tip fabricated from a metal alloy that includes both copper and tungsten in proportions to enhance durability and minimize arc start failures.

2. Description of Related Art

Arc welding processes utilize large amounts of electric current to establish an electric arc between a consumable electrode extending from a welding torch and the metal parts being welded to create the weld joint. From the intense heat, metal at the joint between the metal parts is melted and caused to intermix, either directly or in combination with an molten electrode material. Upon cooling and solidification, a metallurgical bond is created to form the weld joint that secures the metal parts together.

In conventional arc welding processes, such as metal inert gas (“MIG”) welding, also known as gas metal arc welding (“GMAW”), a continuous length of the consumable electrode is fed to an arc welding torch, where it passes through a contact tip which guides the electrode to the welding zone where the metal parts are to be joined. The contact tip is typically a frusto-conical shaped tip with a cylindrical interior passage lined by a metal contact extending along its longitudinal axis through which the consumable electrode can be fed to the welding zone. The metal contact is typically fabricated from a metal, such as copper, that is a good conductor of electric current to supply the levels of current necessary to maintain an arc between the electrode extending from the welding torch and the metal being welded. The metal contact lining the interior passage of the contact tip may be tapered toward its outlet end, and defines a passage having an inside diameter that is sized to afford sliding contact with the electrode as it passes through the welding torch. A suitable amount of electrical current is conducted from the metal contact of the contact tip to the electrode to enable the formation of the arc for melting the metal parts and electrode that will be fused to form the weld joint.

Welding torches, and particularly the contact tips, operate under very severe conditions and wear out very rapidly. Being close to the electrical arc, they are subjected to temperatures anywhere within the range of 6,000° C. to 20,000° C., which may cause warping of the contact tip or fusion of the tip and the consumable electrode. Due to the high temperatures and the materials involved, the contact tip, and the metal contact of the contact tip in particular, can accumulate pollutants over time that inhibit the flow of current through the metal contact to the electrode. Further, high feed rates at which the electrode is fed through the welding torch cause abrasion of the metal contact by the electrode. This abrasion causes enlargement of the inside diameter of the interior passage defined by the metal contact, thereby impairing the electrical contact between the metal contact and the electrode. Thus, the contact tip of an arc welder, such as a MIG welder, must be replaced frequently at great expense to the operator in both parts and labor.

Accordingly, there is a need in the art for a contact tip that includes a metal contact that experiences minimal degradation from abrasion caused by the electrode as it is fed through the welding torch, and that minimizes the occurrence of arc-start failures.

### BRIEF SUMMARY OF THE INVENTION

According to one aspect, the present invention provides an arc-welding contact tip to be provided to a welding torch for establishing an electric connection with a consumable electrode fed to a welding zone through the contact tip during welding operations is disclosed. The contact tip includes a housing to be secured to the welding torch and defining an elongated interior passage through which the consumable electrode is to be fed to the welding zone while the welding operations are being performed. At least a portion of a peripheral surface defining the interior passage is provided with an electrically conductive metal alloy comprising copper and tungsten. Further, the metal alloy includes about 50% by weight to about 90% by weight tungsten.

According to another aspect, the present invention provides an arc-welding contact tip to be provided to a welding torch for establishing an electric connection with a consumable electrode fed to a welding zone through the contact tip during welding operations. The contact tip includes a housing to be secured to the welding torch and defining an elongated interior passage through which the consumable electrode is to be fed to the welding zone while the welding operations are being performed. At least a portion of a peripheral surface of the interior passage defined by the housing is provided with an electrically conductive metal alloy including a weight ratio of tungsten to copper falling within a range of about 60/40 to about 90/10.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is an exploded view of a welding torch in accordance with an aspect of the present invention;

FIG. 2 is a cutaway view of a distal end of a welding torch, such as that shown in FIG. 1, in accordance with an aspect of the present invention;

FIG. 3 is a cutaway view of a contact tip in accordance with an aspect of the present invention, wherein the contact tip is formed from a metal alloy; and

FIG. 4 is a cutaway view of a contact tip in accordance with an aspect of the present invention, wherein the contact tip is provided with a sleeve formed from a metal alloy for defining an interior passage through the contact tip.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

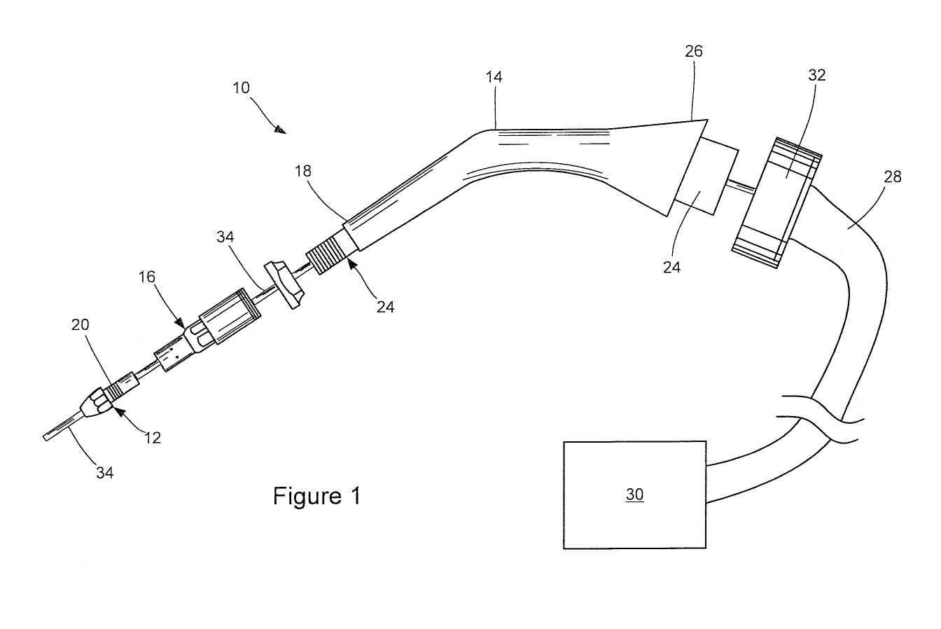

A welding torch with which a tungsten-copper contact tip described below can be used is illustrated as an exploded view in FIG. 1. The welding torch 10 in FIG. 1 is of a type commonly used to perform arc-welding operations, such as metal inert gas (“MIG”) welding, which is also known as gas metal arc welding (“GMAW”). Although described herein in conjunction with a MIG welding torch, the contact tip can be suitably used with a variety of other types of welding devices.

In addition to the contact tip 12, the welding torch 10 also includes a neck portion 14, and a diffuser 16 adjacent to a first end 18 of the neck portion 14. The contact tip 12 is releasably coupled to the diffuser 16 through the cooperation of a threaded portion 20 provided to the contact tip 12 and a mating threaded portion (not shown) recessed within the diffuser 16. A conductor 24 fabricated from an electrically-conductive metal extends through the neck portion 14 from a second end 26 of the neck portion 14 to the first end 18 of the neck portion 14. The conductor 24 is to be coupled to a power line 28 which conducts electric current from a power source 30 to the welding torch 10. The power line can also include a second conduit through which an inert shielding gas is transported from a gas cylinder to the welding torch 10. As described in detail below, the shielding gas is also transported through the neck portion 14 to the diffuser 16, which distributes the gas to form a somewhat cylindrical gas shield around the weld zone to minimize atmospheric contamination of the weld as it is being formed. A quick disconnect coupler 32 can optionally be provided to facilitate rapid connection and disconnection of the welding torch 10 to and from the power line 28.

The power source 30 can supply the large amounts of current required to establish an electrical arc between the metal being welded and a tip of a consumable electrode 34 that is fed through the welding torch 10 as welding operations are being conducted. Depending on the type of welding being done, as well as other variables such as the composition of the electrode 34, the current supplied by the power source 30 can exceed several hundred amps.

The consumable electrode 34 fed through the welding torch 10 as welding operations are being conducted is supplied from within the power source 30 or from a supplemental roll of the electrode wire that is operable with the welding torch 10 and power source 30. The type and diameter of the electrode chosen depends upon the nature of the welding operations to be performed, including the specific metal(s) to be welded, the environment in which the welding operations are to be performed, and the like. Examples of some typical electrode diameters include 0.024 in., 0.030 in., 0.035 in., and 0.045 in.

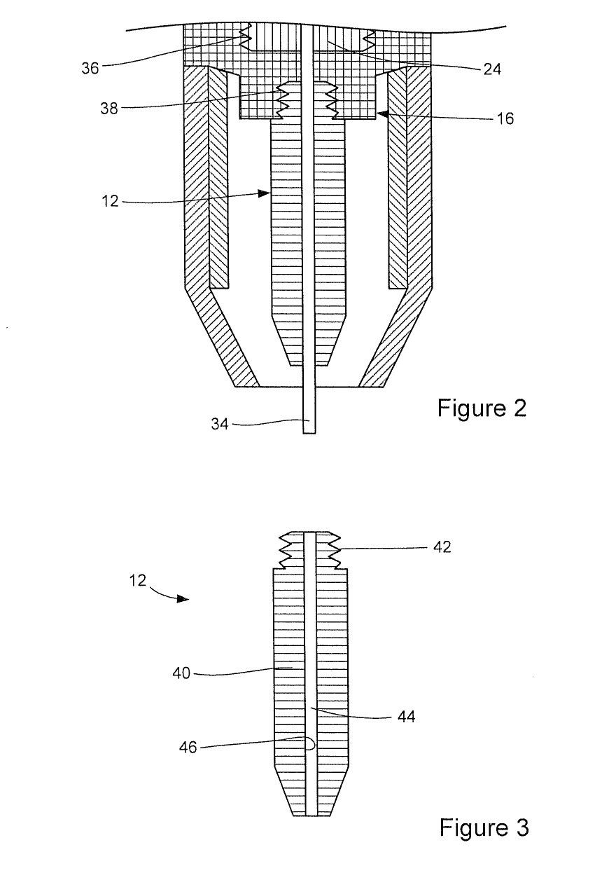

FIG. 2 illustrates an example of a tip arrangement of a welding torch 10 that has been assembled. As shown, the diffuser 16 has been coupled to a terminal end of the electrical conductor 24 that extends from the power line 28 and through the neck portion 14. Contact occurs between the diffuser 16 and the electrical conductor 24 at the locations 36 where the mating threads cooperate to secure the diffuser 16 to the electrical conductor 24. This contact between the diffuser 16 and the electrical conductor 24 establishes a conductive path, or, in other words, an electrical connection therebetween. When so connected, electric current can be conducted from the electrical conductor 24 to the diffuser 16, and vice versa. The diffuser 16 and electrical conductor 24 can each be independently fabricated from a metal or metal alloy that is a good conductor of electricity and can withstand the operating temperatures to be experienced during welding operations conducted with the welding torch 10. Examples of suitable metals and metal alloys include copper, aluminum, tungsten, and alloys including one or more of the foregoing metals.

Likewise, conduction of electric current between the diffuser 16 and the contact tip 12 is also effected by the cooperation of mating threaded portions provided to the contact tip 12 and diffuser 16. The locations 38 where contact occurs between these threaded portions again establishes a conductive path along which electric current can flow. These locations 38 act as electrical contacts that create a circuit between the contact tip 12 and the diffuser 16. Alternate embodiments include electric contacts at locations other than at where mating threaded portions cooperate, and can include dedicated electric contacts (not shown) to establish a conductive path, as well as abutting electrically conductive metallic surfaces. For example, an end portion of the contact tip 12 can abut against a transverse face of the diffuser 16. Thus the end face and the transverse face are in electrically conducting metal-to-metal contact.

As mentioned above, the contact tip 12 is provided to the welding torch 10 for establishing an electric connection (i.e., a conductive path) with the consumable electrode 34 fed to a welding zone through the contact tip 12 during welding operations. While welding operations are being performed with the welding torch 10, the electrode 34 is continuously fed through the welding torch 10. The leading tip of the electrode 34 is consumed due to the extreme temperatures created by the arc between the leading tip of the electrode 34 and the metal being welded. The rate at which the electrode is consumed is approximately the same as the rate at which the electrode 34 is fed though the welding torch 10.

Embodiments of the contact tip 12 in accordance with FIG. 3 include a contact tip 12 that includes a solid housing 40 to be secured to the welding torch 10 through the cooperation of a threaded portion 42 with a mating threaded portion provided to the diffuser 16. FIG. 3 shows a cross sectional view of the contact tip 12 taken along its longitudinal axis, which extends coaxially with the electrode 34 in FIG. 1. The threaded portion 42 is formed integrally as part of the housing 40, which defines an elongated interior passage 44 through which the consumable electrode 34 is to be fed to the welding zone while the welding operations are being performed.

Contact between the contact tip 12 and the consumable electrode 34 must be established to permit the conduction of electric current therebetween. Accordingly, the interior passage 44 includes at least one location along its longitudinal axis 45 that has an inside diameter that is approximately the same as the outside diameter of the consumable electrode 34 to be fed through the contact tip. This inside diameter can vary for each contact tip depending on the outside diameter of the electrode 34 to be used for a particular welding operation. Other embodiments include a substantially cylindrical interior passage 44, wherein the inside diameter of the interior passage 44 is substantially uniform, and approximates the outside diameter of the electrode 34 to be used for a particular welding operation. The similar of these dimensions facilitates continuous contact between the contact tip 12 and the electrode 34 as the electrode is fed through the welding torch 10.

Since the consumable electrode 34 is itself formed from a combination of materials that includes a metal, the sliding of the electrode 34 through the interior passage 44 abrades and wears a peripheral surface 46 that defines the interior passage 44. However, to minimize degradation of the peripheral surface 46 defining the interior passage, at least a portion of the peripheral surface 46 is provided with an electrically conductive metal alloy with enhanced wear resistance comprising copper and tungsten. For the embodiment illustrated in FIG. 3, the entire housing 40, including the peripheral surface 46 and the threaded portion 42, is formed from the metal alloy including a combination of copper and tungsten. However, the mere combination of copper and tungsten to create the metal alloy does not confer the enhanced wear resistance of the present invention. Instead, a metal alloy that comprises about 50% by weight to about 90% by weight tungsten unexpectedly yields superior resistance to wear from the abrasion of the peripheral surface 46 by the electrode 34 as it passes there through.

Alternate embodiments of the metal alloy comprise an amount of tungsten within any of the following ranges: about 55% by weight to about 85% by weight; about 60% by weight to about 80% by weight; about 65% by weight to about 75% by weight; and about 67% by weight to about 83% by weight. According to any of the embodiments, the metal alloy comprises about 10% by weight to about 50% by weight copper.

Specific examples of the metal alloy composition of the contact tip 12 include a metal alloy comprising about 25% by weight copper and about 75% by weight tungsten; about 30% by weight copper and about 70% by weight tungsten; and about 20% by weight copper and about 80% by weight tungsten.

Yet other embodiments of the present invention achieve the unexpected enhanced resistance to wear from the sliding of the electrode 34 against the peripheral surface 46 with a metal alloy including a ratio of tungsten to copper. At least a portion of the peripheral surface 46 is provided with a metal alloy including a weight ratio of tungsten to copper falling within a range of about 60/40 to about 90/10. Alternate embodiments of the metal alloy include a weight ratio of tungsten to copper falling within the following ranges: about 65/35 to about 85/15; and about 70/30 to about 80/20. A specific example of the metal alloy includes a weight ratio of tungsten to copper of about 75/25.

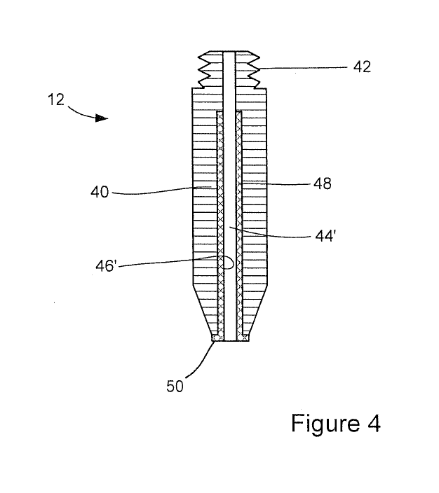

FIG. 4 illustrates an alternate embodiment of the contact tip 12 including a peripheral surface 46′ defining an interior passage 44′. The peripheral surface 46′ is substantially uniformly provided with the metal alloy including tungsten and copper in any of the weight percentages and weight ratios described above. As shown in FIG. 4, the metal alloy is provided to the peripheral surface 46′ as a sleeve 48 formed from the metal alloy inserted into the interior passage 44′. The sleeve 48 can optionally include an outwardly-extending flange 50 that limits the insertion of the sleeve 48 into the interior passage 44′, and allows for removal of the sleeve 48 from the interior passage 44′ when replacement of the sleeve 48 is desired. The sleeve 48 can extend over the entire peripheral surface 46′, or extend over any lesser portion thereof.

Reference to providing the peripheral surfaces 46, 46′ with the metal alloy means that the metal alloy is exposed to the interior of the interior passages 44, 44′ to make contact with the electrode 34 while the electrode is fed through the interior passages 44, 44′. Providing the metal alloy to the peripheral surfaces 46, 46′ can be accomplished by forming the entire housing 40 from the metal alloy, cladding the peripheral surfaces 46, 46′ with the metal alloy, inserting a metal-alloy sleeve 48 into the interior passage, or any combination thereof.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. An arc-welding contact tip to be provided to a welding torch for establishing an electric connection with a consumable electrode fed to a welding zone through the contact tip during welding operations, the contact tip comprising:
a housing to be secured to the welding torch and defining an elongated interior passage through which the consumable electrode is to be fed to the welding zone while the welding operations are being performed, wherein
at least a portion of a peripheral surface defining the interior passage is provided with an electrically conductive metal alloy comprising copper and tungsten, wherein
the metal alloy comprises about 50% by weight to about 90% by weight tungsten.

2. The arc-welding contact tip according to claim 1, wherein the metal alloy comprises about 55% by weight to about 85% by weight tungsten.

3. The arc-welding contact tip according to claim 1, wherein the metal alloy comprises about 60% by weight to about 80% by weight tungsten.

4. The arc-welding contact tip according to claim 1, wherein the metal alloy comprises about 65% by weight to about 75% by weight tungsten.

5. The arc-welding contact tip according to claim 1, wherein the metal alloy comprises about 67% by weight to about 83% by weight tungsten.

6. The arc-welding contact tip according to claim 1, wherein the interior passage includes at least one location along a longitudinal axis of the interior passage having an inside diameter that is approximately the same as an outside diameter of the consumable electrode to be fed through the contact tip.

7. The arc-welding contact tip according to claim 1, wherein the housing is fabricated entirely from the metal alloy.

8. The arc-welding contact tip according to claim 1, wherein the peripheral surface defining the interior passage is substantially uniformly provided with the metal alloy.

9. The arc-welding contact tip according to claim 9, wherein the metal alloy is provided as a sleeve inserted into an aperture formed in the housing.

10. The arc-welding contact tip according to claim 1, wherein the metal alloy comprises about 10% by weight to about 50% by weight copper.

11. The arc-welding contact tip according to claim 1, wherein the metal alloy comprises about 25% by weight copper and about 75% by weight tungsten.

12. The arc-welding contact tip according to claim 1, wherein the metal alloy comprises about 30% by weight copper and about 70% by weight tungsten.

13. The arc-welding contact tip according to claim 1, wherein the metal alloy comprises about 20% by weight copper and about 80% by weight tungsten.

14. The arc-welding contact tip according to claim 1 further comprising an electrical contact in electrical communication with the metal alloy for establishing a conducting path to a ground terminal of a power source when coupled to the welding torch and while welding operations are being performed.

15. The arc-welding contact tip according to claim 1 further comprising an electrical contact in electrical communication with the metal alloy for establishing a conducting path to a positive terminal of a power source when coupled to the welding torch and while welding operations are being performed.

16. An arc-welding contact tip to be provided to a welding torch for establishing an electric connection with a consumable electrode fed to a welding zone through the contact tip during welding operations, the contact tip comprising:
a housing to be secured to the welding torch and defining an elongated interior passage through which the consumable electrode is to be fed to the welding zone while the welding operations are being performed, wherein
at least a portion of a peripheral surface of the interior passage defined by the housing is provided with an electrically conductive metal alloy including a weight ratio of tungsten to copper falling within a range of about 60/40 to about 90/10.

17. The arc-welding contact tip according to claim 16, wherein the weight ratio of tungsten to copper falls within a range of about 65/35 to about 85/15.

18. The arc-welding contact tip according to claim 16, wherein the weight ratio of tungsten to copper falls within a range of about 70/30 to about 80/20.

19. The arc-welding contact tip according to claim 16, wherein the weight ratio of tungsten to copper is about 75/25.

20. The arc-welding contact tip according to claim 16, wherein the interior passage includes at least one location along a longitudinal axis of the interior passage having an inside diameter that is approximately the same as an outside diameter of the consumable electrode to be fed through the contact tip.

21. The arc-welding contact tip according to claim 16, wherein the housing is fabricated entirely from the metal alloy.

22. The arc-welding contact tip according to claim 16, wherein the peripheral surface defining the interior passage is substantially uniformly provided with the metal alloy.

23. The arc-welding contact tip according to claim 22, wherein the metal alloy is provided as a sleeve inserted into an aperture formed in the housing.
